(19) United States
(12) Patent Application Publication
(10) Pub. No.: US 2026/0159308 A1
(43) Pub. Date: Jun. 11, 2026

(54) Biodegradable Organic Waste Disposal Bag Device

(71) Applicant: Randi Manouel, Fresno, CA (US)

(72) Inventor: Randi Manouel, Fresno, CA (US)

(21) Appl. No.: 19/298,662

(22) Filed: Aug. 13, 2025

Related U.S. Application Data
(60) Provisional application No. 63/730,612, filed on Dec. 11, 2024.

(51) Int. Cl. B65F 1/00

(52) U.S. Cl. CPC B65F 1/002; B65F 2250/105; B65F 2250/108; B65F 2250/114

(57) ABSTRACT

A biodegradable organic waste disposal bag device is provided. The device is comprised of a flexible body manufactured from one or more biodegradable and compostable materials. The body may be further comprised of an interior surface treated with a hydrophobic organic wax layer to provide temporary moisture resistance and odor suppression. A reinforced base may also be included to support heavier organic waste loads and is constructed using biodegradable support structures. An opening is located at the top or side of the body and may be defined by a rim reinforced with structural elements to retain shape. A closure mechanism may also be integrated and comprises biodegradable materials. The device is further designed to initiate degradation upon exposure to composting conditions such as elevated moisture and microbial activity, resulting in concurrent decomposition of both the bag and the organic contents of the bag.

### CROSS-REFERENCE TO RELATED APPLICATION

The present application claims priority to, and the benefit of, U.S. Provisional Application No. 63/730,612, which was filed on Dec. 11, 2024, and is incorporated herein by reference in its entirety.

### FIELD OF THE INVENTION

The present invention relates generally to the field of waste bags. More specifically, the present invention relates to a biodegradable organic waste disposal bag that can decompose along with organic waste inside the bag. Accordingly, the present disclosure makes specific reference thereto. Nonetheless, it is to be appreciated that aspects of the present invention are also equally applicable to other like applications, devices, and methods of manufacture.

### BACKGROUND

The widespread use of plastic bags for trash disposal has contributed significantly to environmental degradation. Traditional plastic bags, when discarded, often end up in landfills where they may take up to two decades to decompose. During this prolonged period, they contribute to soil and groundwater contamination and occupy valuable landfill space. Furthermore, when plastic bags are improperly disposed of, they frequently find their way into natural ecosystems, particularly marine environments. In such settings, they pose a substantial threat to wildlife, especially marine animals that may ingest or become entangled in plastic debris. The presence of non-degradable materials in waste disposal systems undermines broader efforts aimed at sustainability and environmental preservation. Organic waste, including food scraps and biodegradable materials, constitutes a significant portion of residential and commercial waste streams. However, when such waste is mixed with plastic bags, it compromises composting initiatives and hinders the effectiveness of green waste processing systems.

Therefore, there exists a long-felt need in the art for a biodegradable organic waste disposal bag device that facilitates the environmentally responsible disposal of organic waste. There also exists a long-felt need in the art for a biodegradable organic waste disposal bag device that degrades naturally under composting conditions without leaving harmful residues. Moreover, there exists a long-felt need in the art for a biodegradable organic waste disposal bag device that prevents plastic pollution in landfills and aquatic environments.

The subject matter disclosed and claimed herein, in one embodiment thereof, comprises a biodegradable organic waste disposal bag device. The device is comprised of a flexible body manufactured from one or more biodegradable and compostable materials. The body may be further comprised of an interior surface treated with a hydrophobic organic wax layer to provide temporary moisture resistance and odor suppression. A reinforced base may also be included to support heavier organic waste loads and is constructed using biodegradable support structures. An opening is located at the top or side of the body and may be defined by a rim reinforced with structural elements to retain shape. A closure mechanism may also be integrated and comprises biodegradable materials. The device is further designed to initiate degradation upon exposure to composting conditions such as elevated moisture and microbial activity, resulting in concurrent decomposition of both the bag and the organic contents of the bag within a time frame of 1 to 90 days without leaving synthetic residues.

In this manner, the biodegradable organic waste disposal bag device of the present invention accomplishes all the foregoing objectives and provides a device for safe and effective containment and disposal of organic waste using compostable materials. The inclusion of biodegradable wax coatings and closure mechanisms further ensures that the device maintains performance during use while facilitating complete integration into composting systems. By disintegrating concurrently with its contents under appropriate conditions, the device prevents contamination of green waste streams and reduces the environmental impact associated with traditional plastic bags. As a result, the biodegradable organic waste disposal bag device addresses long-standing challenges in organic waste management, offering a sustainable alternative that aligns with environmental and regulatory requirements.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a biodegradable organic waste disposal bag device. The device provides a sustainable solution for the containment, transport, and disposal of organic waste. The device supports composting systems, reduces contamination in green waste streams, and complies with regulatory waste diversion goals. The device is comprised entirely of compostable materials and incorporates design elements that promote efficient organic waste management while minimizing environmental impact.

The device is comprised of a flexible body manufactured from biodegradable and compostable materials. The body may assume various shapes such as cylindrical, conical, rectangular, pillow-like, or hybrid geometries, depending on the intended application. An interior surface of the body may be coated, impregnated, or laminated with an organic wax layer. The wax layer provides moisture resistance, inhibits bacterial growth, limits leaching of fluids, and controls odors.

The device may also include a reinforced base to accommodate heavier waste and prevent structural failure. The base may be comprised of reinforcement elements such as cross-woven meshes of natural fibers, multi-ply biodegradable sheets, molded pulp trays, or thermoformed supports. A support structure may be integrated into the base and may include features such as pleats, gussets, scored folds, crimped panels, or rib structures that enable controlled deformation, maintain geometric stability, and support automatic expansion under load.

The body may further include an opening. A rim surrounding the opening may be reinforced with at least one structural element. The opening may include at least one closure mechanism for securing contents during handling. The closure mechanism may be comprised of drawstrings made from biodegradable fibers.

The device is designed to degrade under composting conditions involving moisture, microbes, and elevated temperatures. Decomposition begins through the interaction of the wax layer and internal matrix of the body with organic waste fluids. The body and its contents disintegrate concurrently, allowing full integration into composting processes. The degradation process occurs within 1 to 90 days, depending on material composition and environmental conditions, leaving no synthetic residues or harmful byproducts.

Accordingly, the biodegradable organic waste disposal bag device of the present invention is particularly advantageous as it provides a device for safe and effective containment and disposal of organic waste using compostable materials. The inclusion of biodegradable wax coatings and closure mechanisms further ensures that the device maintains performance during use while facilitating complete integration into composting systems. By disintegrating concurrently with its contents under appropriate conditions, the device prevents contamination of green waste streams and reduces the environmental impact associated with traditional plastic bags. As a result, the biodegradable organic waste disposal bag device addresses long-standing challenges in organic waste management, offering a sustainable alternative that aligns with environmental and regulatory requirements and that overcomes the limitations of existing bags and methods used that are known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a biodegradable organic waste disposal bag device of the present invention while open in accordance with the disclosed architecture;

FIG. 2 illustrates a perspective view of one potential embodiment of a biodegradable organic waste disposal bag device of the present invention while closed in accordance with the disclosed architecture; and

FIG. 3 illustrates a flowchart of a method of using one potential embodiment of a biodegradable organic waste disposal bag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a biodegradable organic waste disposal bag device that facilitates the environmentally responsible disposal of organic waste. There also exists a long-felt need in the art for a biodegradable organic waste disposal bag device that degrades naturally under composting conditions without leaving harmful residues. Moreover, there exists a long-felt need in the art for a biodegradable organic waste disposal bag device that prevents plastic pollution in landfills and aquatic environments.

The present invention, in one exemplary embodiment, is comprised of a biodegradable organic waste disposal bag device. The device offers a sustainable method for containing, transporting, and disposing of organic waste. By supporting composting systems, reducing contamination within green waste streams, and meeting regulatory waste diversion targets, the device promotes efficient organic waste management. The device is further comprised entirely of compostable materials and incorporates design features intended to reduce environmental impact.

The device includes a flexible body formed from biodegradable and compostable materials. An organic wax layer may be applied, impregnated, or laminated to the interior surface of the body to provide moisture resistance, suppresses bacterial growth, reduces leaching of fluids, and controls odors.

A reinforced base may be provided to support heavier waste and prevent structural failure. The base may be comprised of reinforcement components. A structural support may be incorporated into the base that allows for controlled deformation, preserves geometric stability, and facilitates automatic expansion when under load.

The body may be formed with an opening that is surrounded by a rim reinforced with at least one structural element. The opening may be secured by at least one closure mechanism during handling, with the closure mechanism comprising drawstrings made from biodegradable fibers.

The device further enables degradation under composting conditions involving moisture, microbial activity, and elevated temperatures. Decomposition begins through the interaction of the wax layer and the body's internal matrix with organic waste fluids. The body and its contents disintegrate together, enabling complete integration into composting operations. The degradation process may occur within a range of 1 to 90 days, depending on the material composition and environmental factors, and leaves no synthetic residues or harmful byproducts.

As a result, the device provides safe and effective containment and disposal of organic waste through the use of compostable materials. The inclusion of biodegradable wax coatings and closure mechanisms ensures maintained performance during use while allowing seamless integration into composting systems. By disintegrating at the same time as its contents under appropriate conditions, the device prevents contamination of green waste streams and minimizes environmental impact when compared with conventional plastic bags. Therefore, the device resolves long-standing issues in organic waste management and presents a sustainable alternative that meets both environmental and regulatory requirements while addressing the limitations of existing products and methods in the field.

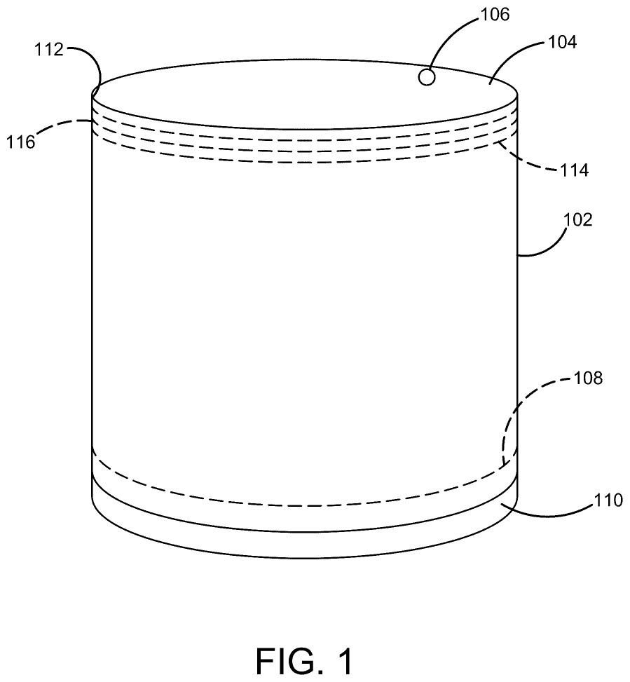

Referring initially to the drawings, FIG. 1 illustrates a perspective view of one potential embodiment of a biodegradable organic waste disposal bag device 100 of the present invention while open in accordance with the disclosed architecture. The device 100 is designed to provide an environmentally sustainable solution for the containment, transport, and disposal of organic waste and other biodegradable organic materials. The primary objective of the device 100 is to facilitate the collection and disposal of organic waste in a manner that supports composting systems, reduces contamination in green waste streams, and aligns with local and state waste diversion regulations. By employing fully compostable materials and integrating functional design elements, the device 100 enables users to manage organic waste efficiently while minimizing environmental impact.

The device 100 may be comprised of a flexible body 102. The body 102 may be manufactured from a homogeneous material or a multilayer composite. The material forming the body 102 may be comprised of but is not limited to any combination of biodegradable and compostable substrates including but not limited to plant-based cellulose fibers derived from wood pulp, cotton linters, or agricultural residues, starch-based biopolymers, polylactic acid (PLA) composites, sugarcane bagasse pulp, chitosan biopolymer films, or biofilm laminates. The body 102 may be a variety of shapes depending on the intended use case. These shapes may include but are not limited to cylindrical forms, tapered conical designs, rectangular prisms, flattened pillow-shaped enclosures, or hybrid geometries combining various cross-sectional profiles.

An interior surface 104 of the body 102 may be coated, impregnated, or laminated with an organic wax layer 106, as seen in FIG. 1. The wax layer 106 may be applied through spraying, brushing, hot rolling, or dip-coating. The layer 106 may be made from of one or more biodegradable hydrophobic compounds, including but not limited to carnauba wax derived from Copernicia prunifera palm leaves, soy wax derived from hydrogenated soybean oil, candelilla wax extracted from Euphorbia cerifera shrubs, beeswax collected from honeybee secretions, sunflower seed wax, rice bran wax, or modified cellulose esters. The wax layer 106 may provide temporary moisture resistance, inhibit bacterial proliferation, reduce leaching of decomposition fluids, and suppress odors associated with volatile organic compounds.

The device 100 may also incorporate a reinforced base 108, as seen in FIG. 1, to support heavier organic waste loads and to prevent sagging or tearing during use. The base 108 may be comprised of multiple reinforcement methods such as but not limited to any combination of cross-woven meshes fabricated from hemp, flax, jute, or kenaf fibers, multi-ply biodegradable sheets, molded pulp trays or thermoformed supports embedded into the base 108, and/or natural fiber reinforcement grids laminated between layers. Additionally, the base 108 may be integrated with a support structure 110. The support structure 110 may be comprised of any combination of pleats, accordion folds, expansion gussets, scored folding zones, crimped panels, or protruding rib structures that allow the base 108 to deform in a controlled manner under load, maintain a stable base geometry, and provide auto-expanding capacity.

The body 102 may further be comprised of an opening 112 located at the top or side of the body 102 depending on configuration, as seen in FIG. 1. The opening 112 may be any combination of but is not limited to circular, elliptical, rectangular, or trapezoidal. A rim 114 may define the boundary of the opening 112 may be reinforced with at least one structural element 116 to maintain an open configuration. The reinforcement 116 may be comprised of but is not limited to any combination of folded-over laminated edge layers, molded compostable fiber rings bonded into the rim, rolled hems formed with pressure sealing or stitch-bonding, or thermoformed PLA edge reinforcements shaped into integral flanges.

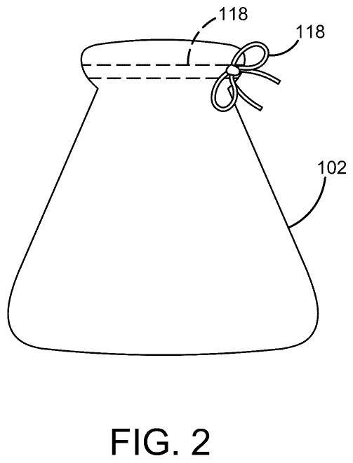

The opening 112 may be equipped with at least one closure mechanism 118 for securing contents within the body 102 during transport or storage, as seen in FIG. 2. The closure mechanism 118 may be comprised of but not limited to drawstrings made from twisted sisal fibers, braided cotton yarns, coiled hemp strands, or linen cords. Additional biodegradable closure mechanisms 118 may include but are not limited to any combination of adhesive bio-gel strips, compostable interlocking zippers made from starch/PVA blends, fold-over flaps, snap-fit PLA clasps, heat-activated wax seals, etc.

Degradation of the device 100 may initiate upon exposure to composting conditions such as elevated moisture, microbial presence, and elevated temperatures. Moisture and decomposition fluids from organic waste may interact directly with the wax layer 106 and inner material matrix of the body 102, initiating physical and biochemical degradation of the body 102. The body 102 and its contents may then begin to disintegrate concurrently, enabling seamless integration into composting cycles. The degradation timeline may vary between 1 to 90 days depending on composting conditions, thickness, and biopolymer formulation. No synthetic polymers, microplastics, heavy metals, or non-organic residues will remain following degradation.

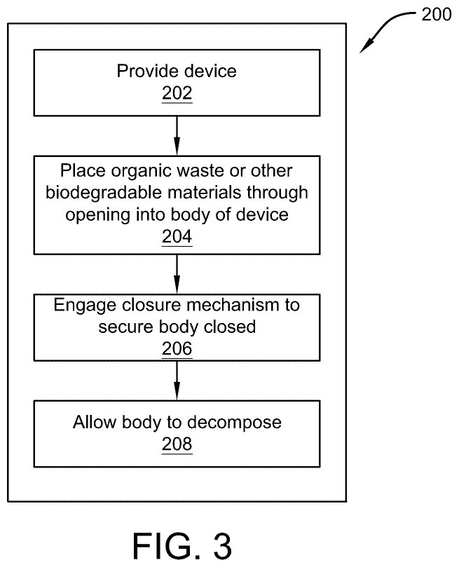

The present invention is also comprised of a method of using the device 100 as seen in FIG. 3. First, a device 100 is provided comprised of a flexible body 102 having an interior surface 104 coated with a biodegradable wax layer 106, a reinforced base 108 with a support structure 110, an opening 112 defined by a rim 114 reinforced with at least one structural element 116, and at least one closure mechanism 118 [Step 202]. Then, organic waste and other biodegradable organic materials can be placed through the opening 112 into the body 102 until a desired fill level is reached [Step 204]. Next, the closure mechanism 118 can be engaged to secure the contents within the body 102 by closing the body 102 for containment, transport, or temporary storage [Step 206]. Finally, the device 100 containing the organic waste can be placed into a composting system where the body 102 will be allowed to degrade under composting conditions, enabling the organic waste and the device 100 to integrate into the composting cycle without leaving non-organic residues [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “biodegradable organic waste disposal bag device” and “device” are interchangeable and refer to the biodegradable organic waste disposal bag device 100 of the present invention.

Notwithstanding the forgoing, the biodegradable organic waste disposal bag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the biodegradable organic waste disposal bag device 100 as shown in the FIGS. are for illustrative purposes only, and that many other sizes and shapes of the biodegradable organic waste disposal bag device 100 are well within the scope of the present disclosure. Although the dimensions of the biodegradable organic waste disposal bag device 100 are important design parameters for user convenience, the biodegradable organic waste disposal bag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A biodegradable organic waste disposal bag device comprising:
a flexible body made from a biodegradable and compostable material;
a biodegradable wax layer positioned on an interior surface of the body; and
a closure mechanism.

2. The biodegradable organic waste disposal bag device of claim 1, wherein the biodegradable and compostable material is comprised of a plant-based cellulose fiber, a starch-based biopolymer, a polylactic acid composite, a sugarcane bagasse pulp, a chitosan biopolymer film, or a biofilm laminate.

3. The biodegradable organic waste disposal bag device of claim 1, wherein the biodegradable wax layer comprises a carnauba wax, a soy wax, a candelilla wax, a beeswax, a sunflower seed wax, a rice bran wax, or a cellulose ester.

4. The biodegradable organic waste disposal bag device of claim 1, wherein the closure mechanism is comprised of a drawstring, an adhesive bio-gel strip, a compostable interlocking zipper, a fold-over flap, a snap-fit clasp, or a heat-activated wax seal.

5. The biodegradable organic waste disposal bag device of claim 1, wherein the body is further comprised of an opening.

6. The biodegradable organic waste disposal bag device of claim 5, wherein the closure mechanism seals the opening.

7. The biodegradable organic waste disposal bag device of claim 5, wherein the opening is further comprised of a rim comprised of a folded-over laminated edge, a molded compostable fiber ring, a rolled hem, or a thermoformed PLA edge.

8. A biodegradable organic waste disposal bag device comprising:
a flexible body made from a biodegradable and compostable material and further comprised of a reinforced base;
a biodegradable wax layer positioned on an interior surface of the body; and
a closure mechanism.

9. The biodegradable organic waste disposal bag device of claim 8, wherein the reinforced base is comprised of a cross-woven mesh, a multi-ply biodegradable sheet, a molded pulp tray, a thermoformed support, or a natural fiber reinforcement grid.

10. The biodegradable organic waste disposal bag device of claim 8, wherein the reinforced base is comprised of a support structure.

11. The biodegradable organic waste disposal bag device of claim 10, wherein the support structure is comprised of a pleat, an accordion fold, an expansion gusset, a scored folding zone, a crimped panel, or a protruding rib structure.

12. The biodegradable organic waste disposal bag device of claim 8, wherein the biodegradable and compostable material is comprised of a plant-based cellulose fiber, a starch-based biopolymer, a polylactic acid composite, a sugarcane bagasse pulp, a chitosan biopolymer film, or a biofilm laminate.

13. The biodegradable organic waste disposal bag device of claim 8, wherein the biodegradable wax layer comprises a carnauba wax, a soy wax, a candelilla wax, a beeswax, a sunflower seed wax, a rice bran wax, or a cellulose ester.

14. A biodegradable organic waste disposal bag device comprising:
a flexible body made from a biodegradable and compostable material and further comprised of a reinforced base;
a biodegradable wax layer positioned on an interior surface of the body; and
a closure mechanism comprised of a biodegradable drawstring.

15. The biodegradable organic waste disposal bag device of claim 14, wherein the biodegradable drawstring is comprised of a twisted sisal fiber, a braided cotton yarn, a coiled hemp strand, or a linen cord.

16. The biodegradable organic waste disposal bag device of claim 14, wherein the reinforced base is comprised of a cross-woven mesh, a multi-ply biodegradable sheet, a molded pulp tray, a thermoformed support, or a natural fiber reinforcement grid.

17. The biodegradable organic waste disposal bag device of claim 14, wherein the reinforced base is comprised of a support structure.

18. The biodegradable organic waste disposal bag device of claim 17, wherein the support structure is comprised of a pleat, an accordion fold, an expansion gusset, a scored folding zone, a crimped panel, or a protruding rib structure.

19. The biodegradable organic waste disposal bag device of claim 8, wherein the biodegradable and compostable material is comprised of a plant-based cellulose fiber, a starch-based biopolymer, a polylactic acid composite, a sugarcane bagasse pulp, a chitosan biopolymer film, or a biofilm laminate.

20. The biodegradable organic waste disposal bag device of claim 8, wherein the biodegradable wax layer comprises a carnauba wax, a soy wax, a candelilla wax, a beeswax, a sunflower seed wax, a rice bran wax, or a cellulose ester.
